(19) United States
(12) Patent Application Publication
(10) Pub. No.: US 2020/0337460 A1
(43) Pub. Date: Oct. 29, 2020

(54) SHELF STATION

(71) Applicant: Hostel Traders Limited, Newcastle upon Tyne Tyne (GB)

(72) Inventor: Mark William Sylvester, Newcastle upon Tyne Tyne (GB)

(73) Assignee: Hostel Traders Limited, Newcastle upon Tyne Tyne (GB)

(21) Appl. No.: 16/963,048

(22) PCT Filed: Jan. 18, 2019
(86) PCT No.: PCT/GB2019/050137

§ 371 Date: Jul. 17, 2020

(30) Foreign Application Priority Data
Jan. 18, 2018 (GB) 1800827.6

(51) Int. Cl. A47B 96/02; H02J 7/00; A47B 96/14

(52) U.S. Cl. CPC A47B 96/021; A47B 96/024; A47B 2097/003; A47B 96/14; A47B 2220/0094; H02J 7/0044

(57) ABSTRACT

A shelf station is disclosed. The shelf station comprises a main body with a storage and mounting surface. The storage surface is non-orthogonal to the mounting surface. The mounting surface comprises one or more electronic components. The location and orientation of the electronic components results in the shelf station being compact and space efficient as, for example, charging cables do not extent beyond the footprint of the shelf station. The electronic components are interchangeable such that the shelf station is customisable. The shelf station features a dovetail mount means, a bevelled lip about the perimeter of the storage surface and a coating providing a soft, non-slip surface.

The present invention relates to a shelf station and in particular a shelf station for use in environments where space is often at a premium e.g. in the hotel and travel industries.

### BACKGROUND TO THE INVENTION

A shelf located close to a power socket provides a suitable place to store an electronic device whilst the device is charging. However, this arrangement is often not an efficient use of the space. Furthermore, power cables extending from the power socket to the shelf can be an inconvenience, an obstruction or indeed a health and safety issue.

In service industries, such as the hotel, travel, food and drink, hair dressing and trade industries space is often at a premium. Within these environments there is often a need for a compact storage solution. One known solution is to provide a shelf station. A shelf station as referred to herein is therefore a shelf with at least one integrated electrical component e.g. a light or power socket.

FIG. 1 depicts a shelf station 1 known in the art. The shelf station 1 comprises a storage surface 2 and a mounting surface 3, the storage surface 3 being orthogonal to the storage surface 2. Items (not shown) can be stored upon the storage surface 2. The mounting surface 3 comprises additional features such as a light 4, a light switch 5 and a power socket 6.

Shelf station 1 of the type presented in FIG. 1 can be found within multiple occupancy hotel rooms where a shelf station may be allocated for each bed. In this way the shelf station provides an individual with a predefined space in a multiple occupancy room e.g. a hostel.

The shelf station 1 however has limited functionality in that it only includes a light 4, a light switch 5 and a power socket 6. Furthermore, as the power socket 6 is located on the mounting surface 3, cables extending from the power socket 6 to an electronic device (not shown) located on the storage surface 2 will protrude away from the shelf defined by the storage surface 2 thus acting as an obstruction, an inconvenience or a health and safety issue.

The shelf station 1 is generally made from medium-density fibreboard (MDF) due to its general availability and low cost. However, the use of MDF makes the shelf station 1 bulky and rigid in order to obtain the desired strength and resilience for use within a service industry. Furthermore, MDF is not particularly water resistant as MDF readily absorbs moisture resulting in swelling and irreversible deformation. Although MDF can be provided with a veneer to improve waterproofing characteristics, these veneers can be easily damaged, particularly through constant use of the shelf station 1 within the service industries. During use, liquids can therefore ingress into the shelf station 1 causing significant damage and therefore increasing the frequency at which the shelf station 1 needs to be replaced.

### SUMMARY OF THE INVENTION

It is an object of an aspect of the present invention to provide a shelf station that obviates or at least mitigates one or more of the aforesaid disadvantages of the shelf station known in the art.

According to a first aspect of the present invention there is provided a shelf station comprising a main body having a storage surface, a mounting surface and one or more electronic components mounted on the mounting surface, wherein the mounting surface is non-orthogonal to the storage surface.

Preferably, the mounting surface is opposite to the storage surface.

Most preferably, the mounting surface is substantially parallel to the storage surface.

Most preferably, the one or more electronic components are mounted substantially parallel to the mounting surface. The one or more electronic components may be mounted within one or more recesses located on the mounting surface.

Preferably, the storage surface comprises a bevelled lip about the perimeter of the storage surface.

Preferably, the main body comprises one or more materials selected from a group of materials comprising plastic, rubber, wood or metal or a combination thereof.

Preferably, the main body further comprise a coating. The coating is preferably made from a different material to that of the main body. Most preferably the coating comprises silicone. Such a coating provides a non-slip, soft-skin for the shelf station.

Preferably, the main body may be a single structure. Alternatively, the main body may be a combination of two or more separate structures.

Optionally the one or more recesses located on the mounting surface comprise an insert. Preferably the insert provides a means for housing one or more electrical boxes. The one or more electrical components may be housed within the one or more electrical boxes.

Preferably, the insert is interchangeable.

Preferably, the one or more electrical boxes are interchangeable.

Most preferably, the number, type and combination of the one or more electronic components are interchangeable.

Preferably, the main body further comprises a chamber, wherein the chamber provides a path for one or more external wires to connect with the one or more electronic components.

Preferably, the one or more external wires comprise a power cable. Optionally, the one or more external wires comprise an ethernet cable.

Most preferably, the shelf station further comprises one or more dovetail joints.

Preferably, the one or more dovetail joints comprise one or more grooves and one or more brackets.

Most preferably, the main body comprises L shaped legs. The L shaped legs facilitate longer grooves.

Optionally, one or more of the dovetail joints comprise a lining. Optionally, the lining comprises aluminium.

Most preferably, the one or more brackets comprise a backplate.

Preferably, the backplate comprises one or more holes. The one or more holes facilitate fixing the bracket directly to a wall.

Optionally, the one or more brackets are mounted upon a rail, wherein the rail comprises holes. The holes facilitate fixing the rail to a wall. The position of the one or more brackets can be adjusted as the bracket can slide along the rail.

Optionally, the backplate comprises a magnetic material.

Alternatively, the shelf station may comprise one or more hooks and a plate. The one or more hooks and plate provide a means for fixing the shelf station in a desired location.

Most preferably, the shelf station further comprises one or more locking mechanisms. The locking mechanism may, for example, provide a means for securing the one or more brackets within the one or more grooves.

Preferably, the one or more locking mechanisms comprise an anti-theft screw.

Alternatively, the one or more locking mechanisms comprise a pin and lock.

Optionally, one of the one or more electronic components is a wireless charging device.

Preferably, the wireless charging device generates a charging area on the shelf station.

Preferably, the charging area is located on the storage surface.

Optionally, one of the one or more components is a Li-Fi connectivity device.

Optionally, shelf station comprises a waveguide. The waveguide transmits, distributes and receives visible light from and directed towards the Li-Fi connectivity device.

According to a second aspect of the present invention there is provided a method for producing a shelf station comprising a main body, the method comprising:
providing the main body with a storage surface, a mounting surface and one or more electronic components mounted on the mounting surface; and
providing the mounting surface non-orthogonal to the storage surface

Preferably, the method further comprises providing the mounting surface opposite to the storage surface.

Most preferably, the method further comprises providing the mounting surface substantially parallel to the storage surface.

Most preferably, the method further comprises providing the one or more electronic components mounted substantially parallel to the mounting surface. The one or more electronic components may be mounted within one or more recesses located on the mounting surface.

Embodiments of the second aspect of the invention may comprise features to implement the preferred or optional features of the first aspect of the invention or vice versa.

According to a third aspect of the present invention there is provided a kit of parts for assembling a shelf station, the kit of parts including:
a main body comprising a storage surface and a mounting surface; and
one or more electronic components for mounting on the mounting surface;
wherein the mounting surface is non-orthogonal to the storage surface.

Embodiments of the third aspect of the invention may comprise features to implement the preferred or optional features of the first or second aspects of the invention or vice versa.

According to a fourth aspect of the present invention there is provided a shelf station comprising a main body having a storage surface, a mounting surface and one or more electronic components mounted on the mounting surface, wherein the mounting surface is at least partially opposite to the storage surface.

Embodiments of the fourth aspect of the invention may comprise features to implement the preferred or optional features of the first to third aspects of the invention or vice versa.

According to a fifth aspect of the present invention there is provided a shelf station comprising:
a main body having a storage surface and a mounting surface, the mounting surface being non-orthogonal to the storage surface;
one or more recesses located on the mounting surface, the one or more recesses comprising an interchangeable insert; and
one or more electronic components mounted within the interchangeable insert.”

Embodiments of the fifth aspect of the invention may comprise features to implement the preferred or optional features of the first to fourth aspects of the invention or vice versa.

### BRIEF DESCRIPTION OF DRAWINGS

There will now be described, by way of example only, various embodiments of the invention with reference to the drawings, of which:

FIG. 1 presents a perspective view of a shelf station known in the art;

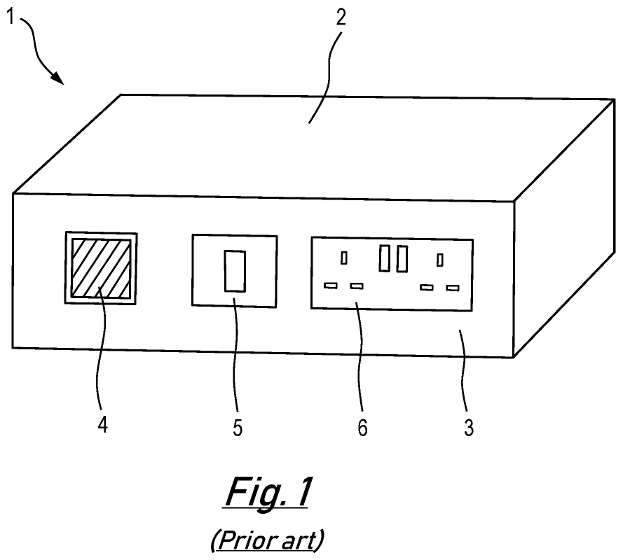

FIG. 2 presents a perspective view of a shelf station in accordance with the present invention;

FIG. 3 presents a cross-sectional schematic representation of a shelf station of FIG. 2;

FIG. 4 presents a top view of the shelf station of FIG. 2;

FIG. 5 presents a back view of a shelf station of FIG. 2;

FIG. 6 presents a perspective view of a component of the shelf station of FIG. 2;

FIG. 7 presents a cross-sectional schematic representation of an alternative of the shelf station of FIG. 2; and

FIG. 8 presents perspective views of (a) prismatic and (b) non-prismatic alternatives of the shelf station of FIG. 2.

In the description which follows, like parts are marked throughout the specification and drawings with the same reference numerals. The drawings are not necessarily to scale and the proportions of certain parts have been exaggerated to better illustrate details and features of embodiments of the invention.

### DETAILED DESCRIPTION OF THE PREFERRED EMBODIMENTS

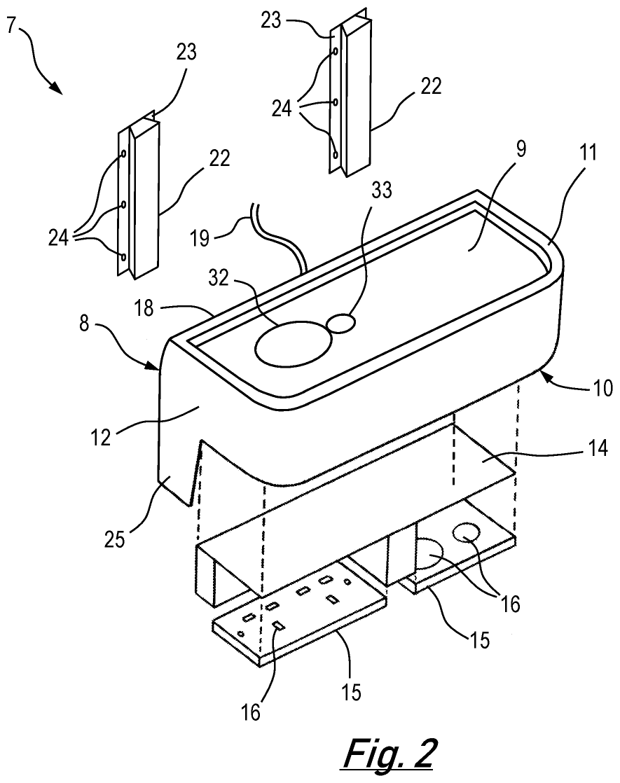

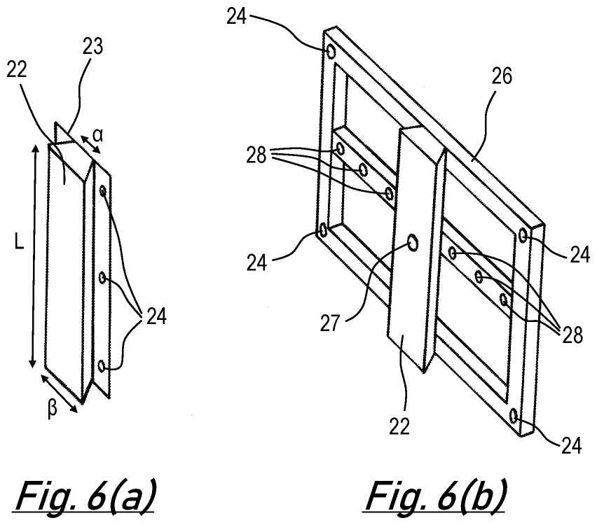

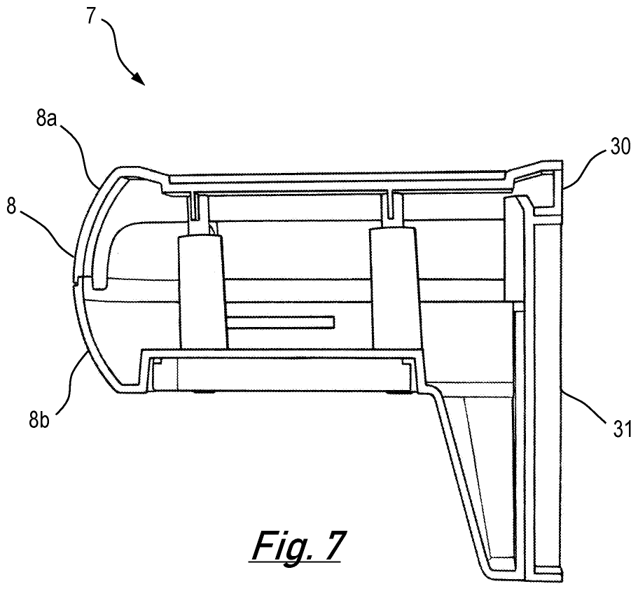

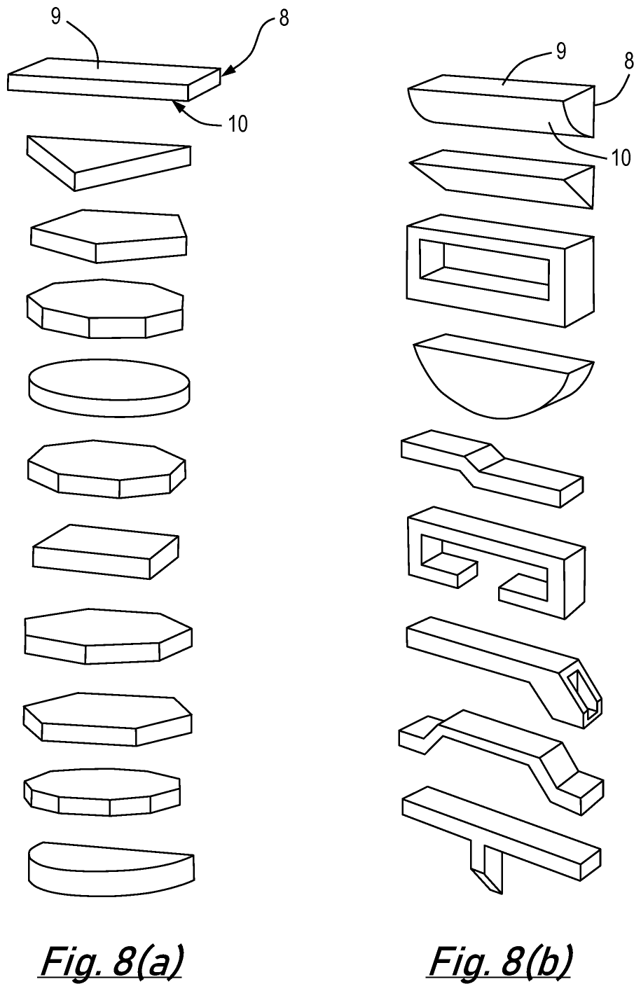

An explanation of the present invention will now be described with reference to FIGS. 2 to 8. In particular, FIGS. 2 to 5 present different views of a shelf station 7 while FIG. 6 presents variants of a component employed to mount the shelf station 7. FIGS. 7 and 8 present alternatives of the shelf station 7.

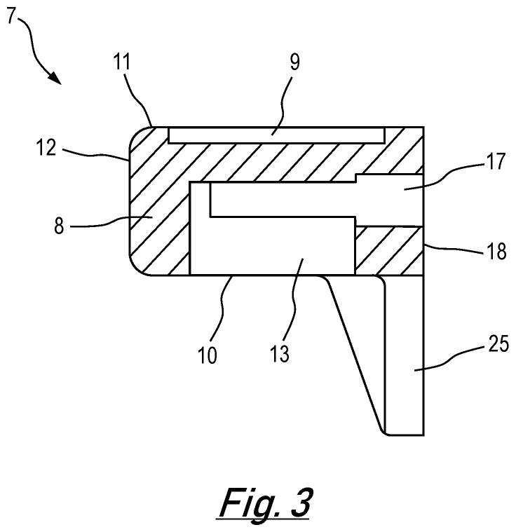

The shelf station 7 comprises a main body 8, as clearly seen in FIG. 2. The main body 8 comprises substantially opposing storage 9 and mounting 10 surfaces, see FIG. 3.

Items (not shown) can be stored upon the storage surface 9 which in situ functions as a shelf.

As an alternative, the mounting surface 10 may be at a non-zero angle relative to the storage 9 surface. The storage surface 9 may also comprise a bevelled lip 11 about the perimeter of the storage surface 9 such that the items located thereon cannot easily roll off the shelf station 7 regardless of the relative angle between the storage 9 and mounting 10 surfaces. The bevelled lip 11 can be seen in FIGS. 2 to 5.

The main body 8 is preferably made of plastic such as polypropylene which is durable, relatively light weight, easy to manufacture and cost effective to produce. An alternative material is rubber, wood, metal or a combination thereof. The main body 8 is also preferably covered with a coating 12 preferably made from silicone; a different material to that of the main body. The coating 12 provides the shelf station 7 with a non-slip, soft-skin.

The main body 8 may be provided as a single structure or as a combination of two or more separate structures. For example, when the main body 8 is made of plastic, the main body 8 may be the combination of an upper 8a and lower 8b moulded structure, see FIG. 7.

The main body 8 comprises a cavity 13 formed from a recess located upon the mounting surface 10 as can been clearly seen in FIG. 3. The cavity 13 houses an insert 14 as depicted in FIG. 2. The insert 14 is preferably made from silicon. The insert 14 may be attached to the main body 8 using screws and or adhesive and or any suitable alternative fixing means. The colour of the insert 14 can be customised accordingly.

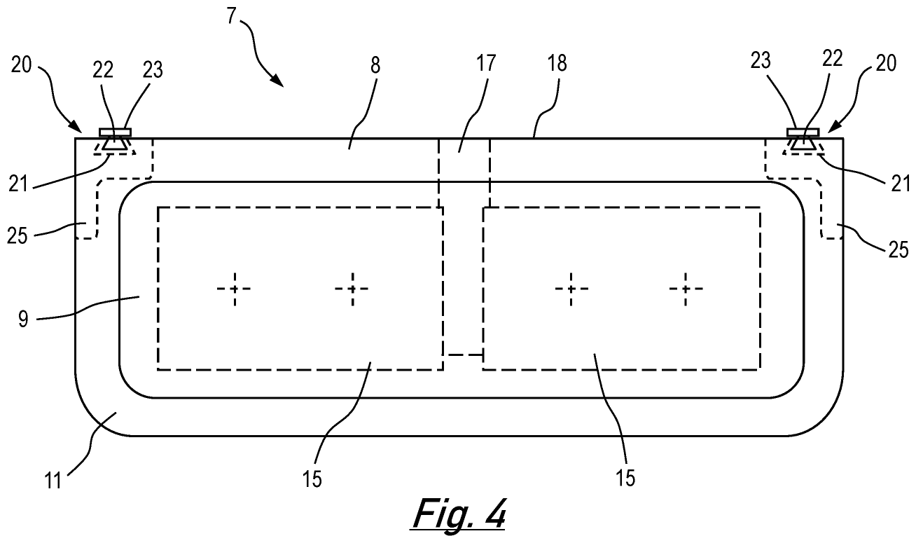

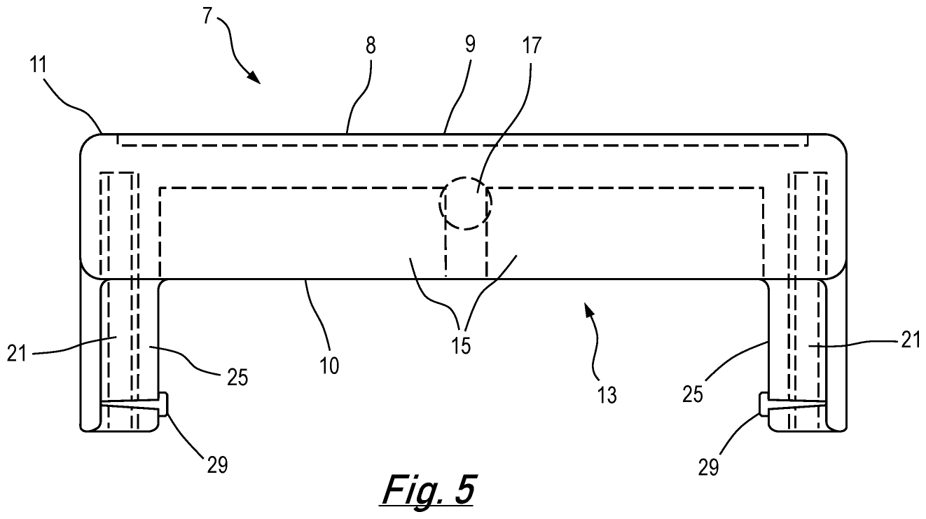

The insert 14 is adapted to house two electrical boxes 15, also commonly referred to as pattress boxes. The electrical boxes 15 can be seen in FIGS. 4 and 5. There exist a range of standard sizes and shapes of electrical boxes 15 available in the art. These different electrical boxes 15 can be interchanged accordingly into the shelf station 7. The insert 14 is also interchangeable with alternative inserts 14 comprising a different configuration. The insert 14 configuration is determined by the desired size and shape of electrical boxes 15.

The electrical boxes 15 may house one or more electrical components 16 which may take the form of a light 4, a light switch 5, a power socket 6, a display screen, an LCD control panel, a speaker, an alarm clock, a radio, a USB charging port, a wireless charging device, a Wi-Fi connectivity device (booster, repeater, extender), a Li-Fi connectivity device, and blue tooth connectivity devices. The number, type and combination of electrical components 16 are interchangeable thus making the shelf station 7 highly configurable. Therefore, the shelf station 7 is customisable accordingly to the desired functionality. For example, the electrical boxes 15 shown in FIG. 2 house two power sockets 6, a light 4 and a light switch 5. As an alternative example, in a hair dresser it is unlikely to be necessary to include a light 4 or a light switch 5 within the shelf station 7 as the main lighting in the hair dresser would be sufficient therefore additional power sockets 6 may be provided within this environment.

The main body 8 further comprises a chamber 17 connecting the cavity 13 to a third surface 18. The third surface 18 preferably extends between the storage 9 and mounting 10 surfaces. See FIGS. 3 to 5 and, more specifically, FIG. 5 shows that the chamber 17 has a circular cross-section. The chamber 17 provides a path through the main body 8 for one or more external wires 19 to connect with the internal electronic components 16. More specifically, the one or more wires 19 may include a power cable with IEC connectors such that the shelf station 7 can be easily disconnected from an external power source (not shown). Additionally, and or alternatively, the one or more wires 19 may include an ethernet cable to provide a cabled internet connection to the electrical components 16 such as the Wi-Fi connectivity devices.

The shelf station 7 further comprises two dovetail joints 20 that provide a means to attach the shelf station 7 to, for example, a wall. Each dovetail joint 20 comprises a groove 21 and a corresponding bracket 22 suitable for locating within the groove 21. The grooves 21 are located on the third surface of the main body 8 as can be seen in FIGS. 4 and 5.

The bracket 22 comprises a backplate 23. As can be seen in FIGS. 2 and 6a, the backplate 23 further comprises holes 24 to facilitate, for example, screwing or bolting the bracket 22 directly to a wall. The shelf station 7 is attached to a wall by first fixing the brackets 22 to the wall and then sliding the grooves 21 of the main body 8 over the brackets 22.

As an additional and or alternative means for fixing the shelf station 7 to a desired location, the backplate 23 may be magnetic. For example, the brackets 22 could be magnetically attached and detached to a ladder or radiator. This magnetic mounting feature further improves the functionality and portability of the shelf station 7.

The main body 8 comprises two L shaped legs 25. The L shaped legs 25 increase the extent of the third surface 18 at either side of the shelf station 7. As a result, the L shaped legs 25 facilitate longer grooves 21 across the third surface 18. The longer grooves 21 and commensurate brackets 22 provide an increased weight capacity of the shelf station 7.

The weight capacity of the shelf station 7 is 20 Kg for a bracket 22 where: a first width α is 0.5 inch (1.27 cm); a second width β is 1 inch (2.54 cm); and the length of the bracket 22, L, is 4 inches (10.16 cm). The parameters α, β and L are shown in FIG. 6a. The dimensions of the corresponding groove 21 mirror that of the bracket 22.

The one or both components of the dovetail joints 20 may be lined with a different material to the composition of the main body 8, such as aluminium. The aluminium would improve the lifetime, strength and ease of use of the dovetail joints 20.

The two brackets 22 are fixed to a wall at a specified spacing such that they align with the two grooves 21 at either end of the shelf station 7. Shelf stations 7 of varying lengths may be provided, in other words, the distance between the two grooves 21 may vary. As shown by FIG. 6b, the brackets 22 may alternatively be mounted upon a rail 26 such that the separation between two brackets 22 can be varied, as appropriate. The bracket 22 can slide within the rail 26 into multiple pre-set positions set by a pin 27 and hole 28 mechanism. Instead of the bracket 22, the rail 26 comprises holes such that the rail can be fixed (by for example screws or bolts) to a wall.

The shelf station 7 may further comprises a locking mechanism 29 to secure the bracket 22 within the associated groove 21. The locking mechanism 29 therefore assists in securing the shelf station 7 to a wall. As can be seen in FIG. 5, the locking mechanism 29 may comprise an anti-theft screw directed into the dovetail joint 20 which prevents the main body 8 of the shelf station 7 being detached from the brackets 22. Alternatively, the locking mechanism 29 may take the form of a pin and lock whereby the pin passes through the dovetail joint 20 and is secured in place by a lock.

The shelf station 7 may also be considered as portable. Multiple sets of brackets 22 could be installed in various locations such that the shelf station 7 could be removed from one location and installed in another location. The shelf station 7 may use a different composition of materials and or functional components to make the device more light-weight, in other words, improve the portability.

As a further additional and or alternative means for fixing the shelf station 7 to a desired location, the shelf station 7 may comprise one or more hooks 30 and a corresponding plate 31, see FIG. 7. The one or more hooks 30 may be located upon the third surface 18 of the main body 8. The one or more hooks 30 may attach to the plate 31 where the plate 31 is fixed to, for example, a wall.

The main body 8 of the shelf station 7 could be considered a prism with a rectangular cross section where the two cross sectional surfaces of the prism are the storage surface 9 and mounting surface 10, respectively. The prism may further comprise the additional features as discussed herein such as the L shaped legs 25. FIG. 8a presents prismatic alternatives to the shelf station 7 where the prism cross section varies in geometrical shape.

Furthermore, FIG. 8b presents non-prismatic, complex shaped alternatives to the shelf station 7, for example, the storage 9 and or mounting 10 surfaces may be curved, irregularly shaped and or multi-faceted. Furthermore, the storage 9 surface may be partially or wholly opposite to the mounting 10 surface.

As an additional, complementary and or alternative feature, when one of the one or more electrical components 16 takes the form of a wireless charging device, the storage surface 9 may comprise a charging area 32, as can be seen in FIG. 2. When a suitable item (not shown), such as a mobile phone, is located on, or partially on, the storage surface 9, in the charging area 32, the item will be wirelessly charged by means of the wireless charging device. The charging area 32 may take the form of markings upon the storage surface 9 to indicate that the shelf station 7 has wireless charging functionality and also the optimal position relative to the wireless charging device to charge an item. As such, it is envisaged the item may still be charged when it is not on, or partially on, the charging area 32 but instead just held close to the shelf station 7. It is further envisaged the charging area 32 could be on any external surface of the shelf station 7.

Furthermore, one of the one or more electrical components 16 may take the form of a Li-Fi connectivity device, in other words, a wireless communication device transmitting and or receiving data using visible light as well as ultraviolet and or infrared radiation. The Li-Fi connectivity device typically requires a direct or indirect line-of-sight to an item, such as a mobile phone, to transmit and receive data. The fastest data connection would be provided by a direct line-of sight as opposed to an indirect line-of-sight. As an additional and or alternative feature, whilst the Li-Fi connectivity device is mounted upon the mounting surface 10 it can be appreciated that one or more Li-Fi connectivity devices could be mounted upon any of the external surfaces of the shelf station 7 to increase the likelihood of a direct line-of-sight and, as a result, maximising the speed of the data connection. As a further additional and or alternative feature, a waveguide 33 may be incorporated within the shelf station 7 to provide a means to transmit, distribute and receive the visible light from and directed towards the Li-Fi connectivity device, again, increasing the likelihood of a direct line-of-sight. The coating 12 of the shelf station 7 may be adapted to provide this functionality.

A key advantage of the shelf station 7 is that the electrical components 16 are located on the mounting surface 10. For example, when a plug and a USB cable for charging an electronic device are plugged into a power socket 6 of the shelf station 7, the plug itself does not protrude beyond the footprint of the shelf station 7. This would not be the case for the shelf station 1 known in the art. Therefore, the shelf station 7 is more space efficient.

A additional key advantage of the shelf station 7 is the interchangeability of the inserts 14, electrical boxes 15 and electronic components 16 with alternatives or variants thereof. In particular, it is advantageous to be able to customise the shelf station 7 to include a different number, type or combination of electronic components 16 depending on the intended use for the shelf station.

Another advantage of the shelf station 7 is the use of the dovetail joints 20 as a mounting mechanism as these are: strong; easy to use and manufacture; and highly versatile. The dimensions of the shelf station 7 can be modified by lengthening or shortening the grooves 21 and brackets 22 to strengthen the mounting or make the shelf station 7 more compact.

The bevelled lip 11 is advantageous as it forms a well-shaped shelf which minimises the risk of items rolling off the surface 9.

The coating 12 is advantageous as it prevents injury by covering sharp edges with a soft skin. Furthermore, the coating provides a non-slip surface which minimises the ease at which an item could roll of the shelf station 7 when in situ. The coating is tactile, ergonomic and the colour and design customised to be aesthetically pleasing.

A shelf station is disclosed. The shelf station comprises a main body with a storage and mounting surface. The storage surface is non-orthogonal to the mounting surface. The mounting surface comprises one or more electronic components. The location and orientation of the electronic components results in the shelf station being compact and space efficient as, for example, charging cables do not extent beyond the footprint of the shelf station. The electronic components are interchangeable such that the shelf station is customisable. The shelf station features a dovetail mount means, a bevelled lip about the perimeter of the storage surface and a coating providing a soft, non-slip surface.

The foregoing description of the invention has been presented for purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

The claims defining the invention are as follows:

1. A shelf station comprising
a main body having an external storage surface and an external mounting surface, the external mounting surface being non-orthogonal to the external storage surface;
one or more recesses located in the external mounting surface;
an interchangeable insert housed within the one or more recesses; and
one or more electronic components mounted within the interchangeable insert.

2. A shelf station as claimed in claim 1 wherein, the external mounting surface is opposite to the external storage surface and or the external mounting surface is substantially parallel to the external storage surface.

3. (canceled)

4. A shelf station as claimed in claim 1 wherein, the one or more electronic components are mounted substantially parallel to the external mounting surface

5.-7. (canceled)

8. A shelf station as claimed in claim 1 wherein the main body further comprise a coating.

9. A shelf station as claimed in claim 8 wherein, the coating is made from a different material to that of the main body.

10. (canceled)

11. A shelf station as claimed in claim 1 wherein, the main body is a single structure or the main body is a combination of two or more separate structures.

12.-13. (canceled)

14. A shelf station as claimed in claim 1 wherein, the insert provides a means for housing one or more electrical boxes.

15. A shelf station as claimed in claim 14 wherein, the one or more electrical components may be housed within the one or more electrical boxes.

16. (canceled)

17. A shelf station as claimed in claim 14 wherein, the one or more electrical boxes are interchangeable.

18. A shelf station as claimed in claim 1 wherein, the number, type and combination of the one or more electronic components are interchangeable.

19. A shelf station as claimed in claim 1 wherein, the main body further comprises a chamber and the chamber provides a path for one or more external wires to connect with the one or more electronic components.

20. A shelf station as claimed in claim 19 wherein, the one or more external wires comprise a power cable and or an ethernet cable.

21.-22. (canceled)

23. A shelf station as claimed in claim 1 wherein, the shelf station further comprises one or more dovetail joints.

24.-30. (canceled)

31. A shelf station as claimed in claim 1 wherein, the shelf station comprises one or more hooks and a plate.

32. A shelf station as claimed in claim 1 wherein, the shelf station further comprises one or more locking mechanisms.

33.-34. (canceled)

35. A shelf station as claimed in claim 1 wherein, one of the one or more electronic components is a wireless charging device, wherein the wireless charging device generates a charging area on the shelf station.

36.-37. (canceled)

38. A shelf station as claimed in claim 1, wherein one of the one or more electronic components is a Li-Fi connectivity device.

39. (canceled)

40. A method for producing a shelf station comprising a main body, the method comprising:
providing the main body with an external storage surface and an external mounting surface, the external mounting surface being non-orthogonal to the external storage surface;
providing one or more recesses located in the external mounting surface;
providing an interchangeable insert housed within the one or more recesses; and
providing one or more electronic components mounted within the interchangeable insert.

41. A method for producing a shelf station as claimed in claim 40 wherein, the method further comprises providing the mounting surface opposite to the storage surface and or providing the mounting surface substantially parallel to the storage surface.

42.-44. (canceled)

45. A kit of parts for assembling a shelf station, the kit of parts including:
a main body comprising an external storage surface and an external mounting surface, the external mounting surface being non-orthogonal to the external storage surface;
one or more recesses located in the external mounting surface;
an interchangeable insert, the interchangeable insert housed within the one or more recesses; and
one or more electronic components for mounting within the interchangeable insert.
